(19) United States
(12) Patent Application Publication
(10) Pub. No.: US 2019/0301393 A1
(43) Pub. Date: Oct. 3, 2019

(54) A COATING METHOD, A THERMAL COATING AND A CYLINDER HAVING A THERMAL COATING

(71) Applicant: OERLIKON METCO AG, WOHLEN, Wohlen (CH)

(72) Inventors: Peter ERNST, Stadel b. Niederglatt (CH); Peter LUETHY, Wohlen (CH); Christian BOHNHEIO, Wohlen (CH); Martin STOECKLI, Boswil (CH); Alexander MICHLA, Hohentengen (DE)

(73) Assignee: OERLIKON METCO AG, WOHLEN, Wohlen (CH)

(21) Appl. No.: 16/304,519

(22) PCT Filed: May 23, 2017
(86) PCT No.: PCT/EP2017/062422

§ 371 Date: Nov. 26, 2018

(30) Foreign Application Priority Data
May 27, 2016 (EP) 16171839.0

(51) Int. Cl. F02F 1/00; B05B 13/06; B05B 12/08

(52) U.S. Cl. CPC F02F 1/004; B05B 7/222; B05B 12/08; B05B 13/0636

(57) ABSTRACT

The invention relates to a coating method for coating a curved surface (1), in particular a concave inner surface (1) of a bore wall or a cylinder wall (2), by means of a powdery coating material (3) by using a thermal spraying device, in particular a plasma spraying device (4) or a HVOF spraying device. A gun (6) is provided on a gun shaft (5) of the thermal spraying device (4) for generating a coating jet (7) from the powdery coating material (3) by means of an arc and the gun (6) is rotated about a shaft axis (A) of the gun shaft (5) at a predetermined rotation frequency (N), wherein the coating jet (7) for applying a coating (8) to the curved surface (1) is directed at least partially radially away from the shaft axis (A) towards the curved surface (1). According to the invention, a higher rotation frequency (N) of the gun (6) is selected with respect to a base rotation frequency (N0) of the gun (6) and the conveying rate (F) of the powdery coating material (3) is changed according to a predetermined scheme in such a way that the conveying rate (F) is adapted to the higher rotation frequency (N) of the gun (6). The invention further relates to a thermal coating (8) and to a coated cylinder.

The invention relates to a coating method for coating a curved surface, in particular a concave inner surface of a bore wall or a cylinder wall, to a thermal coating and to a cylinder having a thermal coating according to the preamble of the independent claim of the respective category.

Thermal spraying methods such as plasma spraying methods or high velocity spraying methods (HVOF) as well as the corresponding thermal spraying devices such as plasma spraying devices, so-called plasma guns, are generally used for coating thermally or mechanically highly stressed parts by melting a suitable material, for example a ceramic or a metal alloy, by means of the arc generated in the plasma gun and applying it to the surface to be coated by means of gas flow support.

As long as the surface to be coated is easily accessible from the outside or has no curved surfaces, it can be coated with a conventional thermal spraying device. However, if, for example, inner walls of bores or tubular geometries are to be internally coated, certain problems arise. If a wall of such a geometry is coated by a conventional thermal spraying device, for example with a plasma spraying device with a plasma jet emitting mainly axially with respect to its longitudinal axis, this is highly inefficient, since only a negligible portion of the molten coating material is effectively applied to the wall located radially with respect to the longitudinal axis of the plasma spraying device.

This problem occurs in technical applications, in particular in the thermal coating of cylinder running surfaces of internal combustion engines, whereby appropriate coatings are applied by various spraying methods according to the state of the art.

Nowadays this is particularly, but not only, widely used in engines for motor vehicles, aircrafts, boats and ships of all kinds.

Today it is common to use plasma spraying devices with a rotating plasma gun for coating the concave inner surfaces of the cylinders or it is also possible to rotate the liner itself. In these special plasma spraying devices, a coating jet exits the plasma gun either perpendicular to the rotation axis of the plasma gun or at a certain angle of inclination to the rotation axis and is thrown onto the cylindrical concave surface, for example, with the aid of a pressurized gas stream, which can often be formed by a noble gas or by an inert gas such as nitrogen, or simply by air to form the desired surface layer. Coating methods or plasma spraying devices that use a thermal spray powder as the starting material for the coating have proved particularly successful in practice. Such a rotating plasma spraying device as well as corresponding plasma spraying methods are already disclosed in EP0601968 A1, for example. Highly modern equipment, such as the SM-F210 guns from Oerlikon Metco, have been in use for a long time and are firmly established in the market. But solutions that use spray wires in rotating guns are also known, as shown for example in WO 2008/037514.

The corresponding cylinder running surfaces are usually activated by various processes before thermal coating, e.g. by corundum jets, hard casting jets, high-pressure water jets, various laser processes or other well-known activation processes. Most frequently, substrates made of light metal alloys based on Al or Mg, but also those based on iron or steel, are pretreated and then coated. The activation of the surfaces guarantees in particular a better adhesion of the thermally sprayed coatings.

There are also special application examples where multi-layer systems appear to be advantageous, which are sprayed one after the other from different coating materials, or which consist of the same material but are applied using different spraying parameters, so that the applied coating obtains very special chemical, physical, topological or other characteristics, which can change, for example, via the layer thickness.

Due to these and a number of other innovative measures, which are now well known to the person skilled in the art, the coating characteristics, in particular also of internal cylinder coatings, have been successively improved until today.

However, it has been shown that different running surface materials also place different demands on the methods with which the coatings are applied.

It has been found that ceramic coating materials such as the applicants proven coating material F6399 (Cr₂O₃), for example, are much more difficult to process than metallic coating materials such as XPT5I2 (a low-alloy carbon steel). This is reflected in particular in an often lower layer application rate and in the resulting longer process time.

Therefore, at least for plasma coating with powdery coating materials, it is common practice in the state of the art to limit the rotation of the gun to a maximum value, whereby at the same time the maximum conveying rate of the powder must also be limited accordingly. The aforementioned limitation of the rotation frequency of the plasma gun unit naturally also applies to the applicant's RotaPlasma™ unit, which is a tool manipulator used to rotate an APS internal gun in order to deposit the powdery material inside a cylinder bore. The limitation of the rotation frequency to around 200 rpm does not only apply to the RotaPlasma™ unit but is also a limitation of the rotation frequency in terms of magnitude, as it is maintained in the state of the art when using other rotating plasma guns which work with powdery materials.

This limitation of the rotation frequency was previously considered necessary in order to prevent excessive residual stresses in the sprayed coatings, which could lead to damaging cracks or other damage to the sprayed coating. This can, for example, lead to fatal consequences if a cylinder liner of an internal combustion engine is coated, which, of course, is well known to the person skilled in the art.

It has been shown that this danger is present not only, but to a particular extent, when ceramic coating materials are used, and therefore leads to the fact that such ceramic coating materials in particular can only be applied with very low conveying rates and the associated relatively low rotation rates of the plasma gun if coatings of sufficient quality are to be produced. This circumstance alone has the consequence that ceramic coatings on cylinder inner surfaces cannot be produced sufficiently economically, especially on an industrial scale.

But even if the coatings are applied with very low rotation rates of the plasma gun and correspondingly low powder conveying rates, nevertheless, such high residual stresses may still occur that cracks or other damage to the applied layers still occur which, although tolerable within certain limits, are of course undesirable, since even, for example, only slightly developed cracks have a negative effect on the quality of the coatings. This plays a decisive role, especially in the case of cylinder coatings for internal combustion engines, since legislators are also placing ever higher demands on environmental standards and fuel consumption, which are fundamentally easier to achieve with coatings of higher quality. Lower-quality coatings naturally also lead to shorter tool lives in operation, thus shortening maintenance intervals and leading to a shorter service life overall and ultimately to higher operating costs for the engines equipped with them.

The object of the invention is therefore to provide a plasma coating method for coating a curved surface, in particular a concave inner surface of a bore wall or of a pipe wall, in particular an inner wall of a running surface of a cylinder bore or of a cylinder liner for internal combustion engines, with which method the disadvantages known from the state of the art are avoided and, in particular, the application of plasma coatings by means of a powdery spray material is significantly improved, so that the coatings produced have massively reduced residual stresses compared to the state of the art, so that they have significantly less or no cracks or other damages, and the coatings can be applied simultaneously more efficiently, faster and more cost-effectively than with the methods known from the state of the art.

The objects of the invention meeting these problems are characterized by the features of the independent claims 1, 12 and 13.

The respective dependent claims refer to particularly advantageous embodiments of the invention.

The invention thus relates to a coating method for coating a curved surface, in particular a concave inner surface of a bore wall or a cylinder wall, by means of a powdery coating material by using a thermal spraying device, in particular a plasma spraying device or a HVOF spraying device. A gun, in particular a plasma gun, is provided on a gun shaft of the thermal spraying device for generating a coating jet from the powdery coating material, especially by means of an arc and the gun is rotated about a shaft axis of the gun shaft at a predetermined rotation frequency, wherein the coating jet for applying a coating to the curved surface is directed at least partially radially away from the shaft axis towards the curved surface. According to the invention, a higher rotation frequency of the gun is selected with respect to a base rotation frequency of the gun and the conveying rate of the powdery coating material is changed according to a predetermined scheme such that the conveying rate is adapted to the higher rotation frequency of the gun.

As already mentioned above, running surface materials, such as the applicant's F6399 (Cr₂O₃), which is well known on the market, are characterized by their ceramic material characteristics. In comparison to metallic coating materials such as XPT512 (low-alloy carbon steel), ceramic materials are generally more difficult to process. This is reflected in particular in an often lower coating application rate and in the resulting longer process time.

Especially this problem was first seriously addressed and finally solved by this invention. Up to now, the maximum rotation speed of plasma guns, such as that of a RotaPlasma™ unit, was limited to approximately 200 rpm, which also limited the maximum conveying rate of the powdery coating materials. The limitation was necessary if one did not want to risk high residual stresses in the layers. This danger is particularly present with ceramic materials and leads to the fact that these can usually only be applied with very low conveying rates, which puts the cost-effectiveness of such ceramic coatings into question.

Contrary to all previous assumptions of the experts, it was now for the first time recognized by the present invention that an increase in the rotation frequency of the plasma gun, e.g. up to 800 rpm or even higher, with a simultaneous suitable increase in the conveying rate of the powdery coating material in the coating method, the coating characteristics can be drastically improved. The essential finding of the invention is therefore that, contrary to all previous assumptions, an increase in the rotation frequency of the plasma gun does not automatically lead to a deterioration of the coating characteristics if only the conveying rate of the powdery coating material is suitably adapted. The spray tests carried out by the inventors have clearly shown that increasing the relative speed between the powder jet and the surface to be coated (as a result of the higher rotation speed) has a positive influence on the coating quality. This can be observed in particular with ceramic coatings. In doing so, in addition to improved coating characteristics, the coating times can also be drastically reduced. A reduction of the coating times for the coating of a cylinder running surface of a cylinder by a factor of 2 to 3 or even more is easily achievable with the method according to the invention.

In addition, the coatings according to the invention, in particular in the upper and lower edge areas of an internally coated cylinder, are of significantly better quality than the coatings known from the state of the art. In this respect, for example, there were always problems with the quality of the coating applied to the cylinder running surfaces of cylinders for internal combustion engines at the upper and lower ends of the cylinders. Since e.g. increased turbulences in the coating jet and/or other negative effects can occur at these edge areas during thermal spraying, these edge areas were often of significantly lower quality, e.g. in terms of porosity, hardness, adhesion, etc., than the rest of the cylinder running surface further inside the cylinders. This deficiency is also substantially eliminated by the present invention, so that coatings of consistently high quality can be produced by the invention, also on the edge areas of a cylinder.

In an embodiment that is particularly preferred in practice, the powdery coating material is conveyed to the plasma gun at a predetermined conveying rate and the conveying rate is adapted to the rotation frequency of the plasma gun in such a way that a higher conveying rate of the powdery coating material is also selected at a greater rotation frequency of the plasma gun. This means that the conveying rate of the powdery coating material is also preferably increased if the rotation speed of the plasma gun is increased. In doing so, despite a shorter processing time by the plasma gun, for example, i.e. despite a faster rotation of the plasma gun, similar or the same layer thicknesses can be produced as with a lower rotation frequency of the plasma gun. The selection of the higher rotation frequency and/or the adaption of the conveying rate to the higher rotation frequency can be made before the start of a coating pass, i.e. before the powder coating material is fed, for example, so that no adaption of the rotation frequency and/or conveying rate is necessary during a coating pass. Here, a coating pass can be understood as the application of a layer with one or more layers of the powdery coating material and/or a further powdery coating material.

In practice, a base rotation frequency of the plasma gun as well as a base conveying rate corresponding to the base rotation frequency for conveying the powdery coating material is often defined and thus predetermined for technical reasons by a plasma gun to be used, such as the RotaPlasma™ unit. In practice, the base rotation frequency of a plasma gun and the base conveying rate corresponding to the base rotation frequency are very often not only dependent on the specific plasma gun unit used but is also determined by the coating material used or also by the geometry of the bore. Therefore, the base rotation frequency and the base conveying rate for a specific coating method must also be selected in many cases in dependence on the spray material.

The base rotation frequency and the base conveying rate are therefore nothing other than the rotation frequency and the conveying rate which has so far been used as standard in the state of the art.

In practice, the rotation frequency is usually selected by a given rotation factor according to N=FM_{N}×N₀ greater than the base rotation frequency in order to achieve a better coating and a shorter coating time, wherein particularly preferred the conveying rate is simultaneously selected to be greater than the base conveying rate by a predetermined conveying factor in accordance with F=FM_{F}×F₀.

In particular, if an unchanged layer thickness of the coating is to be achieved despite of a faster rotation of the plasma gun, the conveying factor can be selected to be equal to the rotation factor. The person skilled in the art understands that a layer thickness of the coating can determine the layer thickness as required by a suitable selection of a factor ratio according to FV=FM_{N}/FM_{F}, but also another layer characteristic of the coating, in particular a hardness, a microhardness, a porosity, a yield strength, an elasticity, adhesion or another layer characteristic of the coating by a suitable selection of the rotation factor and/or by a suitable selection of the conveying factor, in particular by a suitable selection of the factor ratio according to FV=FM_{N}/FM_{F}. The factor ratio FV can be in the range 0.5≤FV≤10, preferably in the range 0.75≤FV≤8, especially preferred in the range 1≤FV≤4, But the factor ratio FV can also be FV=4 or FV=3 or FV=2 or FV=1.

In practice, an increased rotation frequency of a powder plasma gun means, for example, a rotation frequency greater than 200 rpm, preferably greater than 400 rpm or greater than 600 rpm, especially equal to or greater than 800 rpm. An increased conveying rate means, for example, a conveying rate greater than 25 g/min, preferably greater than 50 g/min or greater than 50 g/min, especially equal to or greater than 100 g/min. The increased rotation frequencies and conveying rates mentioned above are particularly typical for plasma gun units of the RotaPlasma™ type. However, they can also be understood universally for other powder plasma gun units, since technically reasonable application rates are mainly determined by the characteristics of the substrate and the spray materials used, especially ceramic or metallic or non-ceramic spray materials, and only secondarily depend on the special type of the rotating plasma gun.

A ceramic coating material, in particular TiO₂ or Cr₂O₃, is preferably used as coating material, in particular for coating cylinder running surfaces for cylinders of internal combustion engines and/or wherein, however, a metallic coating material, in particular a low-alloy steel, especially Fe-1.4Cr61.4Mn1.2C or another coating material, is also advantageously used as coating material.

Depending on the requirement or application, a coating according to the invention may also be applied in a manner known per se in the form of a multilayer coating, which may consist of the same or different coating material, whereby the multilayer coating may then have the same or different layer characteristics, in particular hardness, microhardness, porosity, yield strength, elasticity or adhesive strength.

The invention further relates to a thermal coating on an inner surface of a cylinder wall, in particular on a cylinder running surface of a cylinder of an internal combustion engine, applied by a coating method according to the invention, and to a cylinder for an internal combustion engine with a thermal coating applied by means of a coating method according to the invention.

In the following, the invention is explained in more detail with reference to the drawing.

They show in schematic representation:

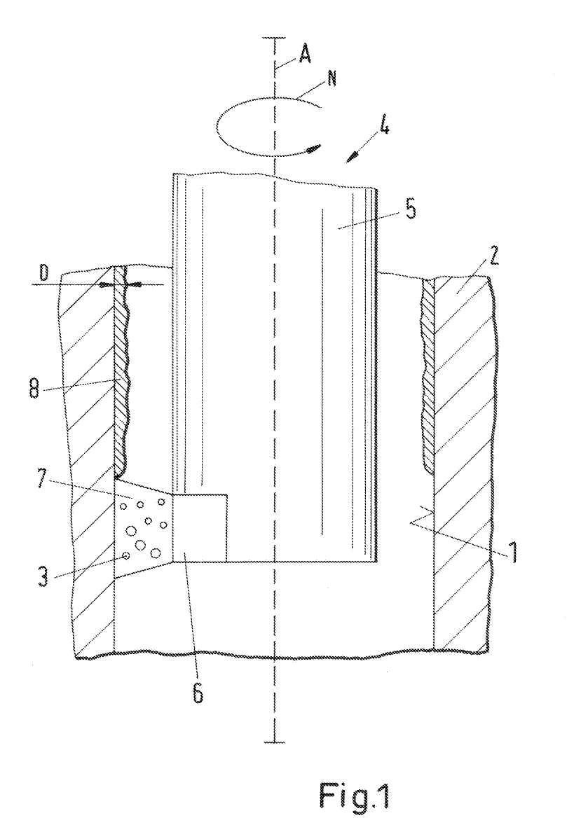

FIG. 1 schematically an embodiment of a coating method according to the invention using the example of a cylinder running surface;

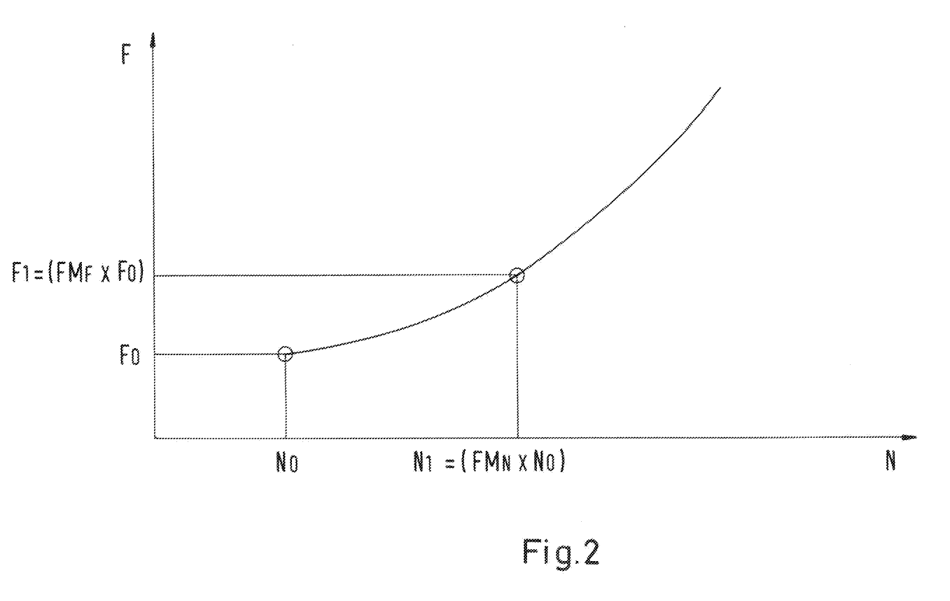

FIG. 2 a schematic diagram to explain the relationship between rotation frequency and conveying rate;

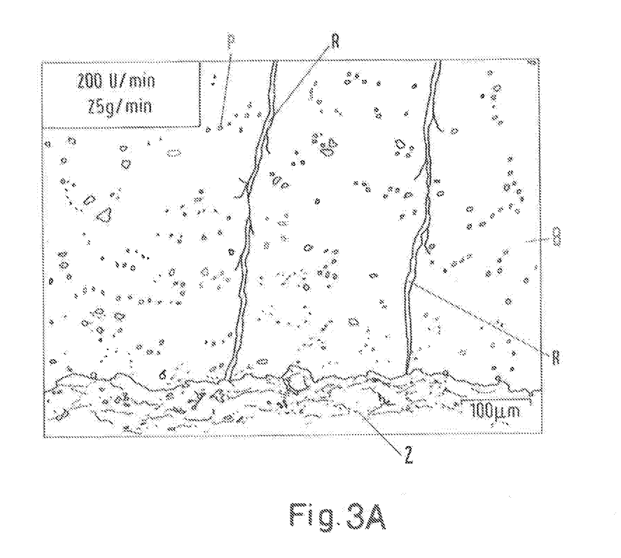

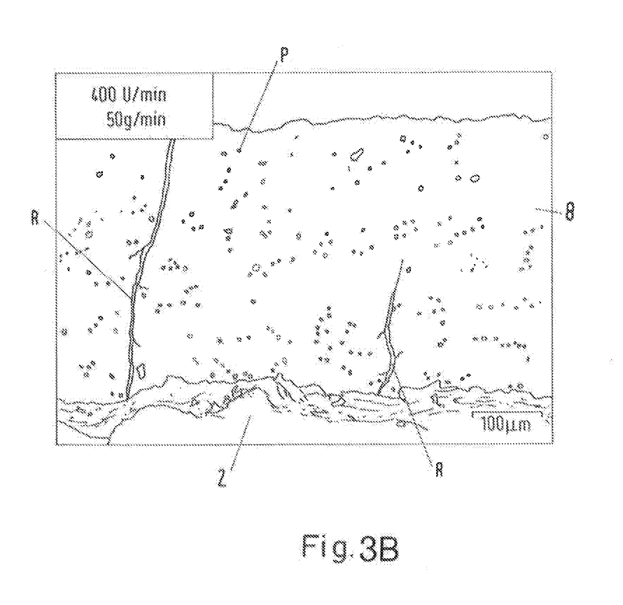

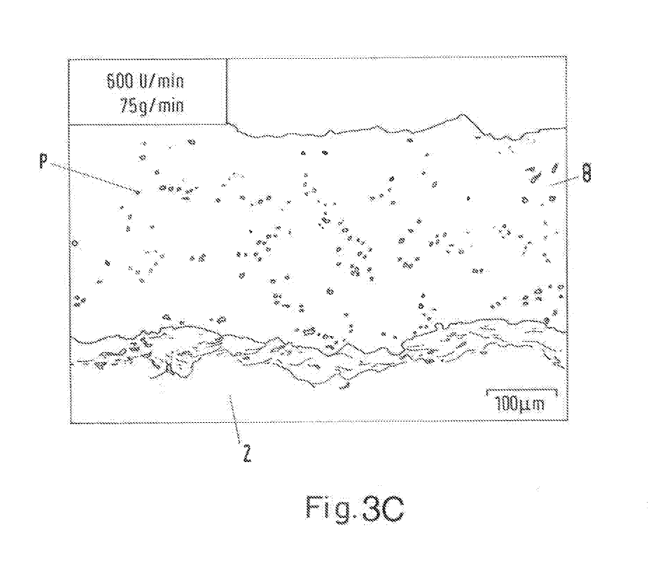

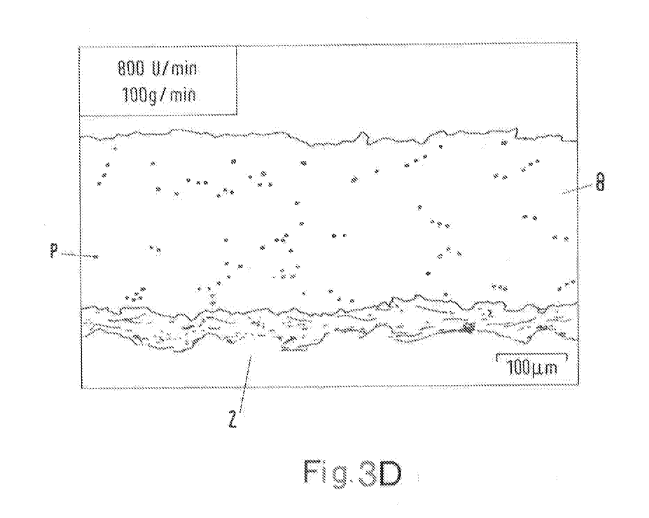

FIG. 3a a graphic representation of a section through a coating of TiO₂ sprayed at 200 rpm;

FIG. 3b a graphic representation of a section through a coating of TiO₂ sprayed at 400 rpm;

FIG. 3c a graphic representation of a section through a coating of TiO₂ sprayed at 600 rpm;

FIG. 3d a graphic representation of a section through a coating of TiO₂ sprayed at 800 rpm;

In the following the invention is explained exemplarily with reference to plasma spraying processes, It is obvious that the invention is not limited to plasma spraying processes but can be carried out with any suitable thermal spraying process, e.g. a HVOF process.

FIG. 1 shows in a schematic representation the execution of a simple embodiment of the method according to the invention by using the example of coating a cylinder running surface of a cylinder of a passenger car engine.

In the method according to the invention represented by FIG. 1, a coating 8 is currently being applied to a curved surface 1, which here is the concave cylinder running surface of a cylinder of a passenger car.

In a manner known per se, a plasma gun 6 is provided on a gun shaft 5 of the plasma spraying device 4 for generating a coating jet 7 from a powdery coating material 3 by means of an arc in accordance with FIG. 1, wherein the plasma gun 6 is arranged rotatably about a shaft axis A of the gun shaft 5 for coating the curved surface 1. In the special example of FIG. 1, the gun shaft 3 rotates at the rotation frequency N, as indicated by the arrow N. The coating jet 7 for applying the coating 8 to the curved surface 1, i.e. here to the cylinder running surface of the cylinder, is directed substantially radially away from the shaft axis A towards the curved surface 1, so that the surface 1 is applied as effectively as possible with the coating material 3. A higher rotation frequency N of the plasma gun 6 was selected with respect to a base rotation frequency N₀ (see FIG. 2) of the plasma gun 6 and the conveying rate F of the powdery coating material 3 was changed according to a predetermined scheme not shown in FIG. 1 in such a way that the conveying rate F is suitably adapted to the higher rotation frequency N of the plasma gun 6. The base rotation frequency of the plasma gun 6 is approx. 200 rpm for the special plasma spraying unit 4 used in FIG. 1, which here for example comprises a RotaPlasma™ unit.

In particular, in the method described in FIG. 1 the powdery coating material 3 is conveyed to the plasma gun 6 at a predetermined conveying rate F and the conveying rate F is adapted to the rotation frequency N of the plasma gun 6 in such a way that a higher conveying rate F of the powdery coating material 3 is also selected in correspondence with the rotation frequency N of the plasma gun 6, which is greater than its base rotation frequency N₀. This means that the conveying rate F is higher than the base conveying rate F₀.

A schematic diagram illustrating the relationship between the rotation frequency N and the conveying rate F is illustrated in FIG. 2. The conveying rate F is plotted on the vertical ordinate axis and the rotation frequency N is plotted on the horizontal abscissa. The plotted curve shows a special example of how the parameter pair (conveying rate F/rotation frequency N) could be selected appropriately for a given plasma spraying device 4 and a powder coating material 3 to be used. The plotted coordinate (F₀/N₀) corresponds to a parameter pair, as it has been used so far in the state of the art, while the parameter (FM_{F}×F₀/FM_{N}×N₀) corresponds to a special parameter pair (F₁/N₁), which is used for coating in a spraying process according to the invention, e.g. as described in FIG. 1.

It is obvious that the course of the curve in FIG. 2 is to be understood purely schematically. In practice, the curve shown in FIG. 2 will very often be a straight line, for example, so that the rotation frequency N and the conveying rate F are always changed with the same factor, so that the same layer thicknesses C of the coating 8 are always achieved even at different rotation frequencies N.

In principle, it is of course also possible to select a parameter pair (N/F) that lies above or below a curve according to FIG. 2. In doing so, it can be achieved, for example, that a smaller or larger layer thickness D is achieved at a different rotation frequency F and/or other parameters of the coating 8, such as in particular a hardness, a microhardness, a porosity, a yield strength, an elasticity, an adhesive strength or another layer characteristic of the coating 8, are determined by a suitable selection of the rotation factor FM_{N} and/or by a suitable selection of the conveying factor FM_{F}, in particular by a suitable selection of the factor ratio FV according to FV=FM_{N}/FM_{F}.

Finally, FIGS. 3a to 3d each show a graphic representation of a section through four coatings of TiO₂, which each were sprayed at different rotation frequencies N and correspondingly adapted different conveying rates F.

FIG. 3a shows a coating 8, which were sprayed onto a cylinder wall 2 by a method according to the state of the art using a RotaPlasma™ plasma spraying device 4. Here, the conventional parameters were selected with a rotation frequency of N=200 rpm and a conveying rate of F=25 g/min. As can be clearly seen, the coating 8 has fine cracks R, which were previously considered tolerable, but fundamentally undesirable. In addition to the cracks R, fine pores P are also visible in all coatings of FIGS. 3a to 3d, which pores are usually desired or even specifically introduced with a predetermined porosity.

The coating 8 according to FIG. 3b was sprayed with a double rotation frequency of N=400 rpm and a double conveying rate of F=50 g/min compared to the state of the art according to FIG. 3a. As can be clearly seen, the formation of cracks R in the coating 8 has reduced. The quality of the coating has therefore already improved considerably.

The coating 8 according to FIG. 3c was sprayed with the threefold rotation frequency of N=600 rpm and a threefold conveying rate of F=75 g/min compared to the state of the art according to FIG. 3a. Here there are practically no more cracks R to be found in the coating 8. The quality of the coating has therefore improved even further.

The coating 8 according to FIG. 3d was finally sprayed with the fourfold rotation frequency of N=800 rpm and a fourfold conveying rate of F=100 g/min compared to the state of the art according to FIG. 3a. Here there are no more cracks R at all to be found in the coating 8. The quality of the coating has therefore improved even further and is to be regarded as ideal for practical use.

It is clear that the invention is not limited to the embodiments described and, in particular, that all suitable combinations of the embodiments depicted are covered by the invention.

1. A coating method for coating a curved surface (1), in particular a concave inner surface (1) of a bore wall or cylinder wall (2), by means of a powdery coating material (3) by using a thermal spraying device (4), in particular a plasma spraying device (4) or a HVOF spraying device, wherein a gun (6) is provided on a gun shaft (5) of the thermal spraying device (4) for generating a coating jet (7) from the powdery coating material (3) by means of an arc, and the gun (6) is rotated about a shaft axis (A) of the gun shaft (5) at a predetermined rotation frequency (N), wherein the coating jet (7) for applying a coating (8) to the curved surface (1) is directed at least partially radially away from the shaft axis (A) towards the curved surface (1), characterized in that a higher rotation frequency (N) of the gun (6) is selected with respect to a base rotation frequency (N₀) of the gun (6) and the conveying rate (F) of the powdery coating material (3) is changed according to a predetermined scheme in such a way that the conveying rate (F) is adapted to the higher rotation frequency (N) of the gun (6).

2. A coating method according to claim 1, wherein the powdery coating material (3) is conveyed to the gun (6) at a predetermined conveying rate (F) in such a way and the conveying rate (F) is adapted to the rotation frequency (N) of the gun (6) such that at a higher rotation frequency (N) of the gun (6), a higher conveying rate (F) of the powdery coating material (3) is also selected.

3. A coating method according to claim 1, wherein the base rotation frequency (N₀) of the gun (6) and a base conveying rate (F₀) corresponding to the base rotation frequency (N₀is predetermined for conveying the powdery coating material (3).

4. A coating method according to claim 3, wherein the base rotation frequency (N₀) and the base conveying rate (F₀) corresponding to the base rotation frequency (N₀) is selected depending on the coating material used (3).

5. A coating method according to claim 3, wherein the rotation frequency (N) is selected to be greater than the base rotation frequency (N₀) by a predetermined rotation factor (FM_{N}) according to N==FM_{N}×N₀ and at the same time the conveying rate (F) is selected to be greater than the base conveying rate (F₀) by a predetermined conveying factor (FM_{F}) according to F=FM_{F}×F₀.

6. A coating method according to claim 5, wherein the conveying factor (FM_{F}) is selected equal to the rotation factor (FM_{N}).

7. A coating method according to claim 5, wherein a layer thickness (D) of the coating (8) is determined by the selection of a factor ratio (FV) according to FV=FM_{N}/FM_{F}.

8. A coating method according to claim 5, wherein a layer characteristic of the coating (8), in particular a hardness, a microhardness, a porosity, a yield strength, an elasticity, an adhesive strength or another layer characteristic of the coating (8), is determined by a suitable selection of the rotation factor (FM_{N}) and/or by a suitable selection of the conveying factor (FM_{F}), in particular by a suitable selection of the factor ratio (FV) according to FV=FM_{N}/FM_{F}.

9. a coating method according to claim 1, wherein the rotation frequency (N) is greater than 200 rpm, preferably greater than 400 rpm or greater than 600 rpm, especially equal to or greater than 800 rpm.

10. a coating method according to claim 1, wherein the conveying rate (F) is greater than 25 g/min, preferably greater than 50 g/min or greater than 50 g/min, especially equal to or greater than 100 g/min.

11. A coating method according to claim 1, wherein the coating material (3) is a ceramic coating material (3), in particular TiO₂ or CrO₃ and/or wherein the coating material (3) is a metallic coating material (3), in particular a low-alloy steel, especially Fe-1.4Cr-1.4Mn1.2C.

12. A coating method according to claim 1, wherein said multilayer coating (8) consisting of the same or different coating material (3) is applied and/or wherein the multilayer coating (8) has the same or different layer characteristics, in particular hardness, microhardness, porosity, yield strength, elasticity or adhesive strength.

13. A thermal coating (8) on an inner surface (1) of a cylinder wall (2), in particular on a cylinder running surface of a cylinder of an internal combustion engine, applied by a coating method according to claim 1,

14. A cylinder for an internal combustion engine having a thermal coating (8) according to claim 13 applied to the cylinder running surface of the cylinder by means of the coating method.
